(19) United States
(12) Patent Application Publication
(10) Pub. No.: US 2016/0107106 A1
(43) Pub. Date: Apr. 21, 2016

(54) PRINTING ENGINEERED FLUID FILTERS

(71) Applicant: LAWRENCE LIVERMORE NATIONAL SECURITY, LLC., Livermore, CA (US)

(72) Inventor: Erik P. Brown, Tracy, CA (US)

(73) Assignee: LAWRENCE LIVERMORE NATIONAL SECURITY, LLC, Livermore, CA (US)

(21) Appl. No.: 14/515,301

(22) Filed: Oct. 15, 2014

(51) Int. Cl. B01D 29/00

(52) U.S. Cl. CPC B01D 29/0093

(57) ABSTRACT

A fluid filter produced by additive manufacturing that includes a filter body having an entrance face for fluid entrance, an exit face for fluid exit, at least one pore in the fluid filter body extending from the entrance face to the exit face, and at least one pocket in the pore. The fluid containing the particles flows through the pore from the entrance face to the exit face and the particles are directed into the pocket where the particles become trapped in the pocket.

### FEDERALLY SPONSORED RESEARCH AND DEVELOPMENT

The United States Government has rights in this application pursuant to Contract No. DE-AC52-07NA27344 between the United States Department of Energy and Lawrence Livermore National Security, LLC for the operation of Lawrence Livermore National Laboratory.

### BACKGROUND

1. Field of Endeavor

The present application relates to fluid filters and more particularly to printing fluid filters.

2. State of Technology

This section provides background information related to the present disclosure which is not necessarily prior art.

One of the problems with filter manufacturing is that they all involve the application, disposition or random layering of small fibers to create a mat of filtration media. This process creates three primary factors that affect the performance of the filters; fiber size, fiber spacing and fiber strength. The main performance criteria are filtration, strength and backpressure. Smaller fiber size can create greater filtration but at the cost of strength and backpressure and visa versa. Typical filters are made by randomly laying down a mat of small fibers densely enough to leave only small holes. As the mat gets denser, the holes get smaller and filtration is increased allowing only smaller and smaller particles to pass. However as the mat gets denser there is less open area to allow the fluid to pass and the backpressure increases. What is needed is just the right amount of material in the rite place to create small fluid flow paths preferably with areas to collect particulates without clogging, with a minimum of excess material i.e. an engineered matrix.

### SUMMARY

Features and advantages of the disclosed apparatus, systems, and methods will become apparent from the following description. Applicant is providing this description, which includes drawings and examples of specific embodiments, to give a broad representation of the apparatus, systems, and methods. Various changes and modifications within the spirit and scope of the application will become apparent to those skilled in the art from this description and by practice of the apparatus, systems, and methods. The scope of the apparatus, systems, and methods is not intended to be limited to the particular forms disclosed and the application covers all modifications, equivalents, and alternatives falling within the spirit and scope of the apparatus, systems, and methods as defined by the claims.

Applicant has developed a fluid filter produced by additive manufacturing. Applicant's development includes modeling of a fluid filter enabling analysis and development of the best fluid filter design. Once the best filter design has been developed the fluid filter is manufactured by additive manufacturing. A fluid filter produced by additive manufacturing that includes a filter body having an entrance face for fluid entrance, an exit face for fluid exit, at least one pore in the fluid filter body extending from the entrance face to the exit face, and at least one pocket in the pore. The term “pore” as used in this application means a flow channel for the fluid being filtered. The fluid containing the particles flows through the pore from the entrance face to the exit face and the particles are directed into the pockets where the particles become trapped in the pockets. The application of additive manufacturing provides rapid prototyping to the making of fluid filters. By using rapid prototyping by additive manufacturing, fluid filters with greater efficiency, greater material retention, and less back pressure can be made. In addition the filters can be customized for flow, material retention and filtration efficiency. The filters can be made out of many materials to resist corrosion, chemical reactions, materials for sintering, materials that promote electrostatic retention, or possibly out of catalytic or reactive materials. This invention includes variations to use different flow paths to capture and retain particulates; use of intumescent materials to control pore sizes, including reductions of pore sizes to less than the printer resolution; and use of multiple materials within the filter. Because they are printed and the pore sizes and fluid paths are engineered rather than random as in typical filters, printed filters are more efficient with less backpressure.

Applicant's filters can be used wherever existing filters are used. They can be made of materials that are not normally used for filters because of the way exiting filters are manufactured. Additive manufactured filters can be used as air filters, filters in hydraulic systems, and other fluid systems. They can be used in high hazard applications.

The apparatus, systems, and methods are susceptible to modifications and alternative forms. Specific embodiments are shown by way of example. It is to be understood that the apparatus, systems, and methods are not limited to the particular forms disclosed. The apparatus, systems, and methods cover all modifications, equivalents, and alternatives falling within the spirit and scope of the application as defined by the claims.

### BRIEF DESCRIPTION OF THE DRAWINGS

The accompanying drawings, which are incorporated into and constitute a part of the specification, illustrate specific embodiments of the apparatus, systems, and methods and, together with the general description given above, and the detailed description of the specific embodiments, serve to explain the principles of the apparatus, systems, and methods.

FIG. 1 illustrates one embodiment of Applicant's fluid filter designed and produced by additive manufacturing.

FIG. 2 is an enlarged view of a portion of the filter shown in FIG. 1.

FIG. 3 is an enlarged view of another portion of the filter shown in FIG. 1.

FIG. 4 is an enlarged view of a portion of the filter shown in FIG. 1.

FIG. 5 illustrates another embodiment of Applicant's fluid filter designed and produced by additive manufacturing.

FIG. 6 illustrates additional details of the filter shown in FIG. 5.

FIG. 7 illustrates another embodiment of Applicant's fluid filter designed and produced by additive manufacturing.

FIG. 8 illustrates yet another embodiment of Applicant's fluid filter designed and produced by additive manufacturing.

FIG. 9 illustrates another embodiment of Applicant's fluid filter designed and produced by additive manufacturing.

FIG. 10 illustrates yet another embodiment of Applicant's fluid filter designed and produced by additive manufacturing.

FIG. 11 is a flow chart illustrating one embodiment of an additive manufacturing system for producing Applicant's fluid filter.

FIGS. 12A and 12B provide an illustration of one embodiment of an additive manufacturing system for producing Applicant's fluid filter.

FIG. 13 is a flow chart illustrating another embodiment of an additive manufacturing system for producing Applicant's fluid filter.

FIGS. 14A-14D provide an illustration of another embodiment of an additive manufacturing system for producing Applicant's fluid filter.

### DETAILED DESCRIPTION OF SPECIFIC EMBODIMENTS

Referring to the drawings, to the following detailed description, and to incorporated materials, detailed information about the apparatus, systems, and methods is provided including the description of specific embodiments. The detailed description serves to explain the principles of the apparatus, systems, and methods. The apparatus, systems, and methods are susceptible to modifications and alternative forms. The application is not limited to the particular forms disclosed. The application covers all modifications, equivalents, and alternatives falling within the spirit and scope of the apparatus, systems, and methods as defined by the claims.

Applicant has developed a fluid filter produced by additive manufacturing or 3-D printing. The term “additive manufacturing” as used in this application means any processes for making three-dimensional objects and includes 3-D printing. Applicant's development includes modeling of a fluid filter enabling analysis and development of the best fluid filter design. Once the best filter design has been developed the fluid filter is manufactured by additive manufacturing.

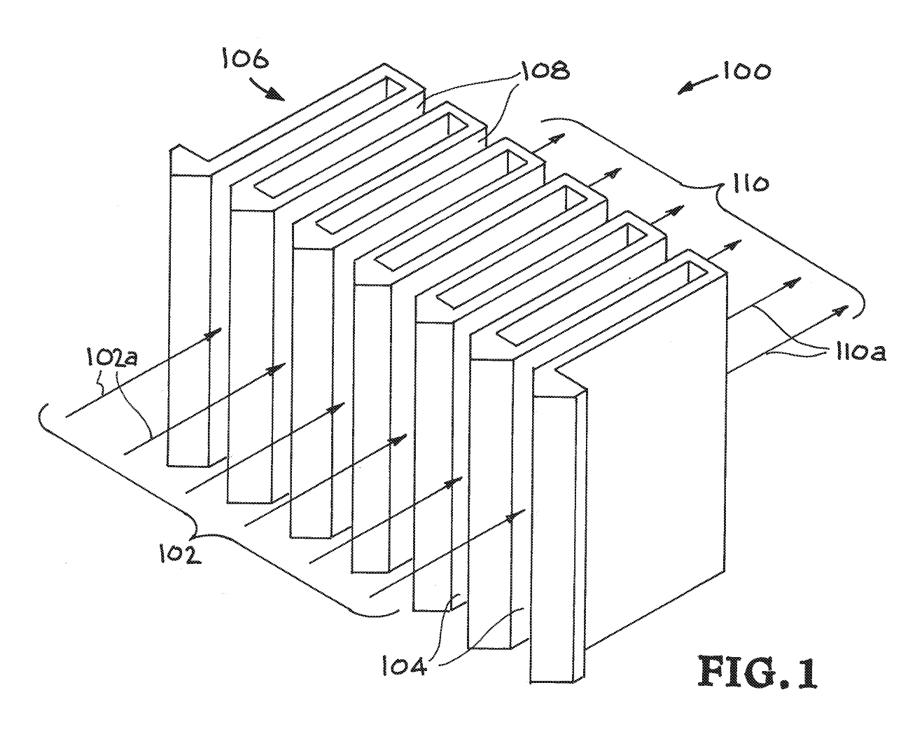

Referring now to the drawings, and in particular to FIG. 1 of the drawings, one embodiment of Applicant's fluid filter designed and produced by additive manufacturing is illustrated. The fluid filter is designated generally by the reference numeral 100. The filter 100 is produced by additive manufacturing that produces a filter wall 106. The filter wall has a multiple connected “S” shape which provides entrance slots 104 and exit slots 106. As shown in FIG. 1 the entrance fluid 102 enters the filter through the entrance slots 104 and after passing through the pores in the entrance slots 104 the fluid 110 exits through a portion of the wall 106. The entrance fluid 102 entering the filter 100 is illustrated by the arrows 102a. The exit fluid 110 exiting the filter 100 is illustrated by the arrows 110a. The fluid filter 100 provides filtration of a fluid being filtered that flows through the filter 100.

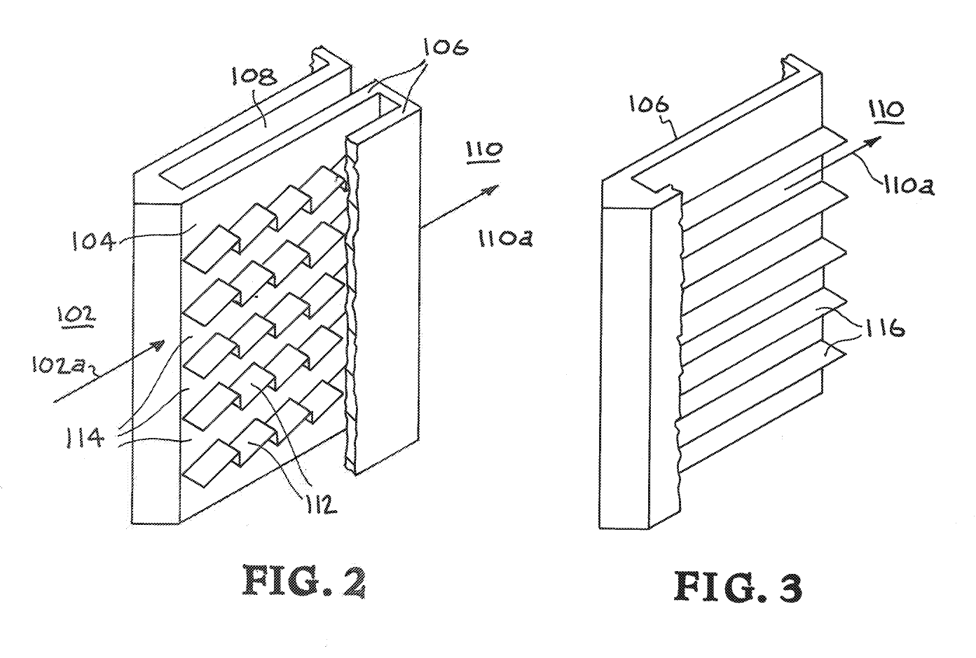

Referring now to FIG. 2, an enlarged view of a portion of the filter 100 is shown. The portion of the filter 100 shown in FIG. 2 is an enlarged view of entrance slot 104 and the exit slot 108 with particular focus on the entrance slot 104. A series of zig zag baffles 112 are located in the entrance slot 104. The zig zag baffles 112 are positioned one above the other and provide pores 114 between the baffles 112 that allow the entrance fluid 102 to flow through the pores 114. The entrance fluid 102 flows into the area between the baffles 112 and through the pores 114. The fluid being filtered passes through the portion of the wall 106 of the filter 100 after passing through the pores 114. The exit fluid 110 is illustrated flowing out of the filter after passing through the wall 106 by the arrow 110a. The open area entrance to the areas between the baffles 112 is considered an entrance face. The zig zag baffles 112 perform the additional function of keeping the filter walls 106 in position.

Referring now to FIG. 3, another enlarged view of a portion of the filter 100 is shown. The portion of the filter 100 shown in FIG. 3 is an enlarged view of the exit slot 108. A series of support baffles 116 are located in the exit slot 108. The support baffles 116 are positioned one above the other and provide support and stiffening of the filter wall 106. The flow of the exit fluid 110 is illustrated by the arrow 110a.

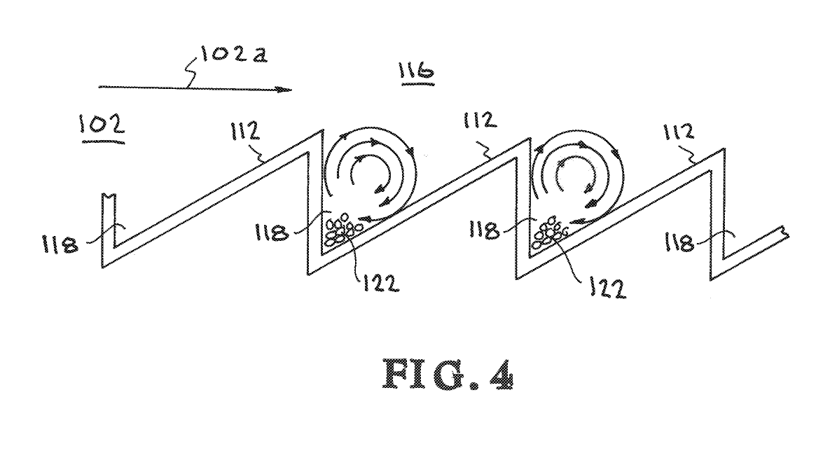

Referring now to FIG. 4, an enlarged view of the pores 116 and the zig zag baffles 112 is shown. The zig zag baffles 112 include pockets 118. The entrance fluid 102 flows through the pores 116 as indicated by the arrow 102a. As the entrance fluid 102 flows through the pores 116 the zig zag baffles 112 create eddies 120 in the entrance fluid flow 102a adjacent the pockets 118. The eddies 120 cause particles 122 in the entrance fluid 102 to become trapped in the pockets 118.

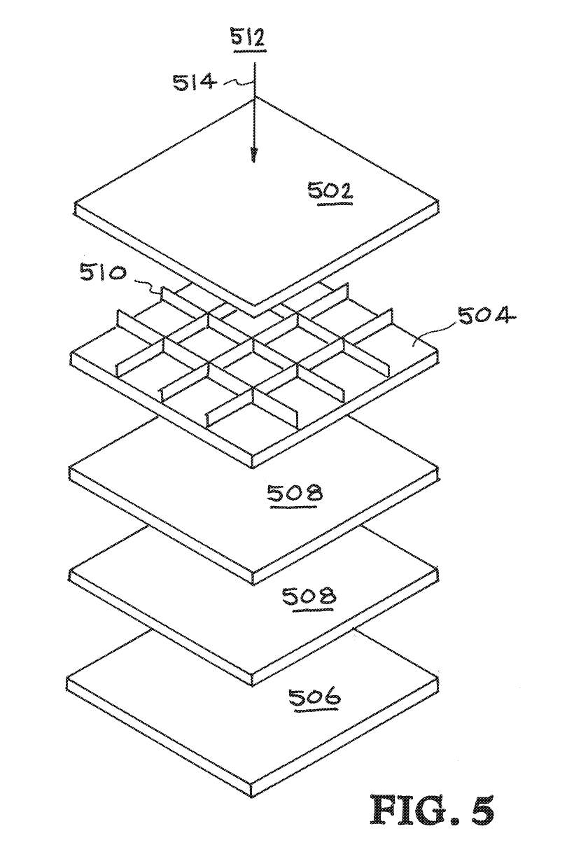

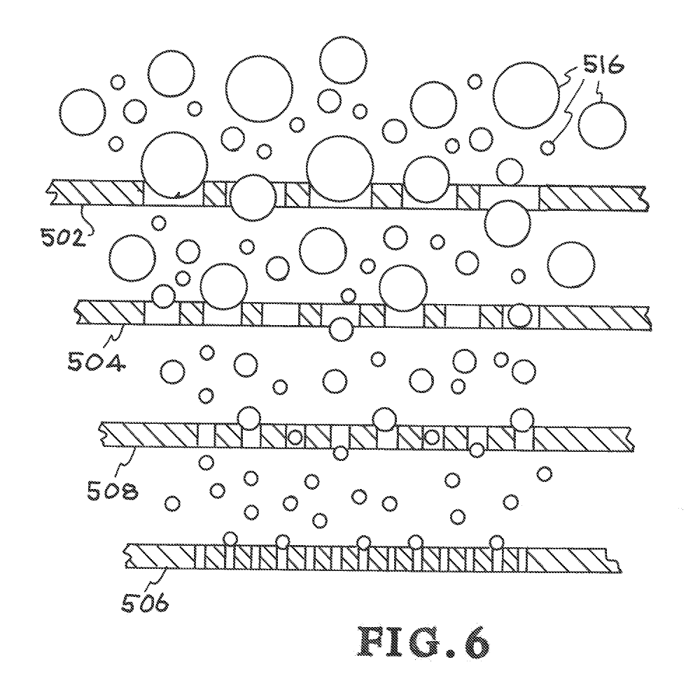

Referring now to FIGS. 5 and 6, another embodiment of Applicant's fluid filter designed and produced by additive manufacturing is illustrated. This embodiment of the fluid filter is designated generally by the reference numeral 500. The filter 500 is produced by additive manufacturing and provides filtration of a fluid that flows through the filter 500.

FIG. 5 illustrates how a multi-layered porous filter can be constructed. The multi-layered filter wall can be constructed of few or many layers as required by the fluid/medium to be filtered. The fluid/medium 512 it be filtered would enter the first wall 502 in the direction indicated by the arrow 514. This first layer 502 of the multi-layered filter wall could be 50% porosity and trap the largest particles. An egg crate separator 510 would be inserted between first filter layer 502 and second filter layer 504. Second filter layer 504 might be of 30% porosity and filter out the next largest particles. Other filter layers not shown here could be incorporated into a multi-wall filter wall.

The filter 500 has a first layer 502, a second layer 504, and a final layer 506. Additional intermediate layers 508 can be included between the second layer 504 and the final layer 506. The first layer 502 is designed to screen larger particles. For example, the first layer 502 may have 50% porosity. The second layer 504 is designed to provide additional screening of particles. For example, the second layer 504 may have 30% porosity. The final layer 506 is designed to screen the smallest particles. For example, the final layer 506 may have 5% porosity. The intermediate layers 508 are designed to provide additional screening of particles. For example, the intermediate layers 508 may have porosity to provide a gradient between the first, second and final layers. A separator 510 is positioned between the first, second, intermediate and final layers.

As shown in FIGS. 5 and 6 the fluid 512 to be filter enters the first layer 502 as indicated by the arrow 514. After passing through the first layer 502 wherein the larger particles 516 are caught, the fluid passes through the second layer 504 wherein additional particles 516 are screened out.

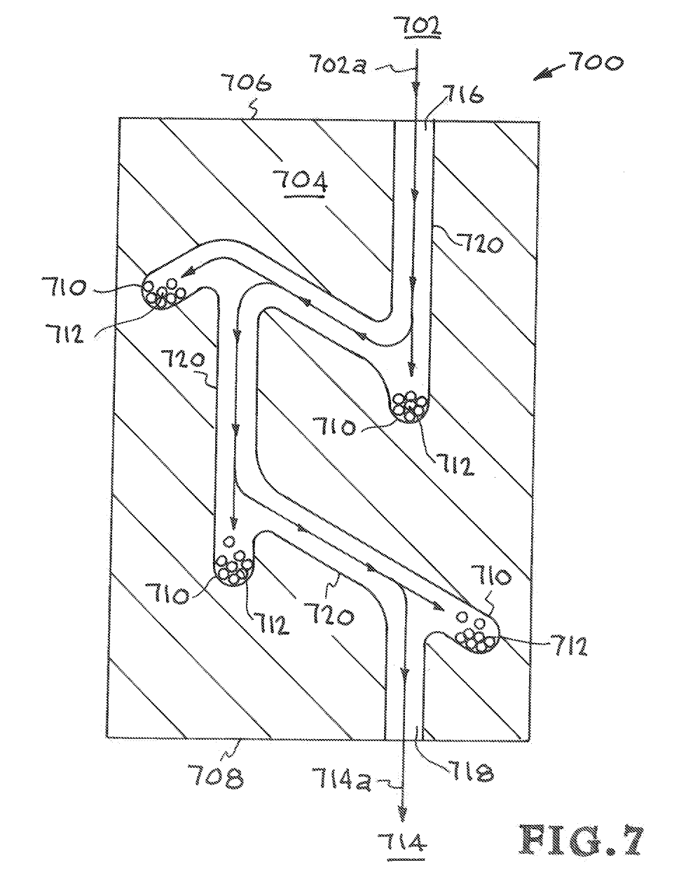

Referring now to FIG. 7, another embodiment of Applicant's fluid filter designed and produced by additive manufacturing is illustrated. This embodiment of the fluid filter is designated generally by the reference numeral 700. The filter 700 is produced by additive manufacturing and provides filtration of a fluid that flows through the filter 700.

The filter 700 has a filter body 704 with and entrance side 706 and an exit side 708. The filter body 704 has an entrance opening 716 and an exit opening 718. A pore 720 extends through the filter body 704 connecting the entrance opening 716 with the exit opening 718.

As shown in FIG. 7 the fluid 702 enters the filter body 704 through the entrance opening 716 as indicated by the arrow 702a. After passing through the pore 720 in the filter body 704 the fluid 702 exits through the exit opening 718. The pore 720 includes pockets 710. The fluid 702 flows through the pore 720 as indicated by the arrows. As the fluid 702 flows through the pore 720 the change of direction of fluid flow creates eddies in the fluid flow adjacent the pockets 710. The eddies cause particles 712 in the fluid to become trapped in the pockets 712.

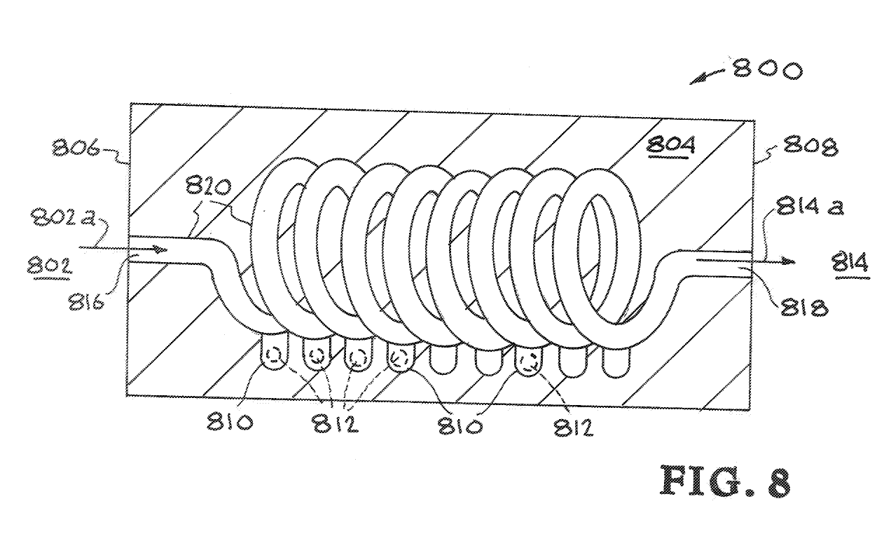

Referring now to FIG. 8, another embodiment of Applicant's fluid filter designed and produced by additive manufacturing is illustrated. This embodiment of the fluid filter is designated generally by the reference numeral 800. The filter 800 is produced by additive manufacturing and provides filtration of a fluid that flows through the filter 800.

The filter 800 has a filter body 804 with and entrance side 806 and an exit side 808. The filter body 804 has an entrance opening 816 and an exit opening 818. A pore 820 extends through the filter body 804 connecting the entrance opening 816 with the exit opening 818.

As shown in FIG. 8 the fluid 802 enters the filter body 804 through the entrance opening 816 as indicated by the arrow 802a. After passing through the pore 820 in the filter body 804 the fluid 802 exits 814 through the exit opening 818 as indicated by arrow 814a. The pore 820 includes pockets 810. The fluid 802 flows through the pore 820 in a swirling manner. As the fluid 802 flows through the pore 820 swirls are created in the fluid flow. The swirls cause particles 812 in the fluid to become trapped in the pockets 812.

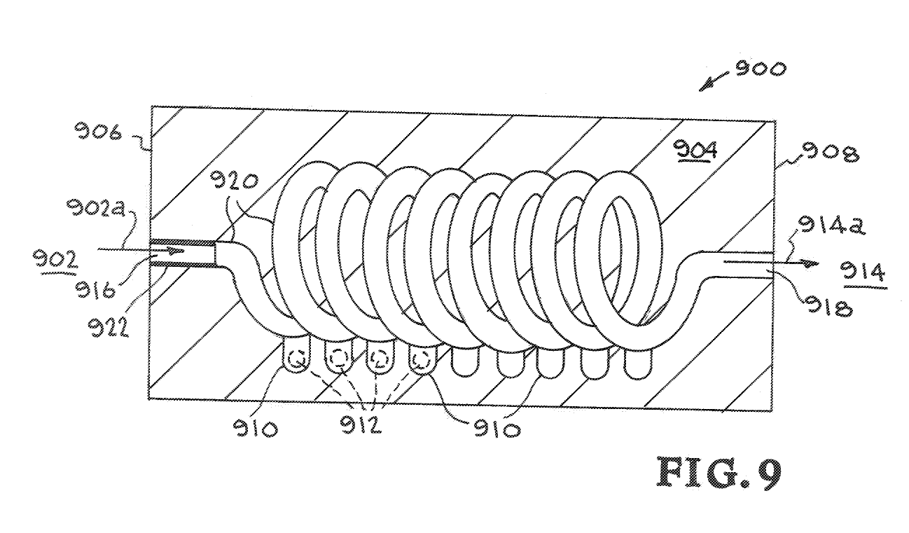

Referring now to FIG. 9, another embodiment of Applicant's fluid filter designed and produced by additive manufacturing is illustrated. This embodiment of the fluid filter is designated generally by the reference numeral 900. Applicant's filter apparatus may exposed to heat and an intumescent material in the pore will expand and block the pores if the filter apparatus is exposed to heat. An intumescent material is one that undergoes a chemical change when exposed to heat or flames, becoming viscous then forming expanding bubbles that harden into a dense, heat insulating multi-cellular char.

The filter 900 is produced by additive manufacturing and provides filtration of a fluid that flows through the filter 900. The filter 900 has a filter body 904 with and entrance side 906 and an exit side 908. The filter body 904 has an entrance opening 916 and an exit opening 918. A pore 920 extends through the filter body 904 connecting the entrance opening 916 with the exit opening 918. An intumescent material 922 is located in the pore 920.

As shown in FIG. 9 the fluid 902 enters the filter body 904 through the entrance opening 916 as indicated by the arrow 902a. After passing through the pore 920 in the filter body 904 the fluid 902 exits through the exit opening 918. The pore 920 includes pockets 910. The fluid 902 flows through the pore 920 in a swirling manner. As the fluid 902 flows through the pore 920 swirls are created in the fluid flow. The swirls cause particles 912 in the fluid to become trapped in the pockets 912. The intumescent material 922 in the pore 920 will undergo a chemical change when exposed to heat becoming viscous and form expanding bubbles that harden into a dense, heat insulating multi-cellular char blocking the pore 920 if the filter apparatus is exposed to heat.

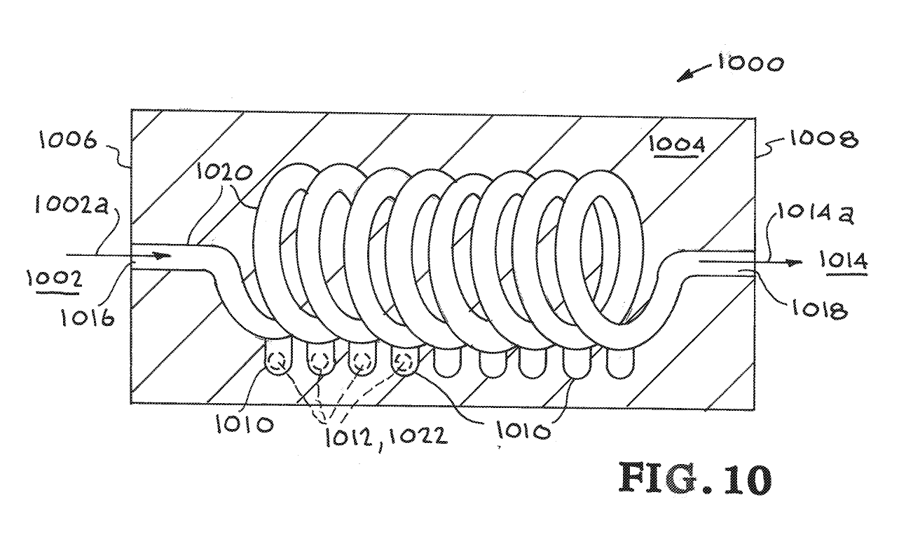

Referring now to FIG. 10, another embodiment of Applicant's fluid filter designed and produced by additive manufacturing is illustrated. This embodiment of the fluid filter is designated generally by the reference numeral 1000. The fluid being filtered may contain contaminates. A reactive material is located in the pores that will react with the contaminates.

The filter 1000 is produced by additive manufacturing and provides filtration of a fluid that flows through the filter 1000. The filter 1000 has a filter body 1004 with and entrance side 1006 and an exit side 1008. The filter body 1004 has an entrance opening 1016 and an exit opening 1018. A pore 1020 extends through the filter body 1004 connecting the entrance opening 1016 with the exit opening 1018. A reactive material 1022 is located in the pores 1020 that will react with the contaminates.

As shown in FIG. 10 the fluid 1002 enters the filter body 1004 through the entrance opening 1016 as indicated by the arrow 1002a. After passing through the pore 1020 in the filter body 1004 the fluid 1002 exits through the exit opening 1018. The pore 1020 includes pockets 1010. The fluid 1002 flows through the pore 1020 in a swirling manner. As the fluid 1002 flows through the pore 1020 swirls are created in the fluid flow. The swirls cause particles 1012 in the fluid to become trapped in the pockets 1012. The reactive material 1022 located in the pores 1020 will react with the contaminates.

Applicant has developed a fluid filter produced by additive manufacturing. Applicant's filters may be produced by additive manufacturing using any one of a number of processes. One of the processes for producing a fluid filter produced by additive manufacturing involves using two head disposition printing with one head depositing organic and the other head depositing inorganic materials.

Two Head Disposition Printing

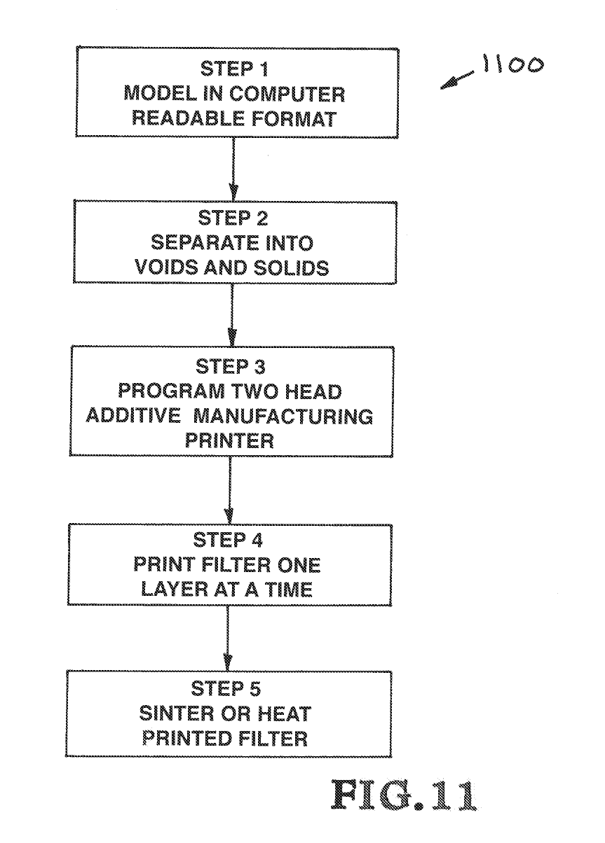

Referring now to FIG. 11, a flow chart illustrates one embodiment of an additive manufacturing system for producing Applicant's fluid filter. The flow chart illustrates a series of steps for producing Applicant's fluid filter by additive manufacturing. The steps are described below.

Step 1: Provide high resolution model of 3D filter in a computer readable format.

Step 2: Separate high resolution model of 3D filter into voids and solids.

Step 3: Program a two head additive manufacturing printer to print ceramic, metal, inorganic or relatively high temperature material in solid spaces using one head and relatively lower temperature organic material in void spaces using the other head.

Step 4: Print the filter one layer at a time. Each layer will be a solid layer made up of individual ceramic, metal, inorganic or relatively high temperature material, and organic relatively lower temperature droplets.

Step 5: Sinter or heat the printed filter. In the sintering or heating process the individual ceramic, metal, inorganic or relatively high temperature material will coalesce, and the organic relatively lower temperature material will decompose leaving the desired paths and voids in the final filter.

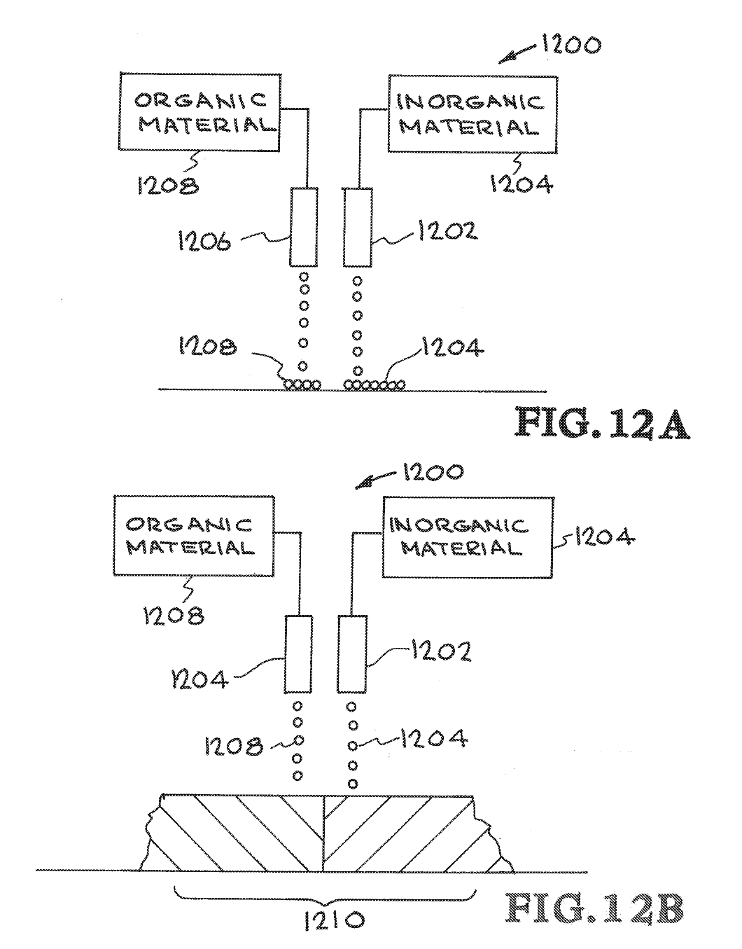

Referring now to FIGS. 12A and 12B, an embodiment of an additive manufacturing system for producing Applicant's fluid filter is illustrated. The additive manufacturing system is designated generally by the reference numeral 1200. The system 200 uses two head disposition printing with one head depositing organic material and the other head depositing inorganic material.

The system 200 produces a fluid filter using adaptive manufacturing with two print heads. A three dimensional model of the fluid filter is produced in a computer readable format. The three dimensional model is separated into void spaces and solid spaces. As illustrated in FIG. 12A, one of the print heads 1202 prints inorganic material 1204 in the solid spaces. The other of the print heads 1206 prints organic material 1208 in the void spaces.

As illustrated in FIG. 12B, the fluid filter 1210 is printed one layer at a time wherein each layer can include the inorganic material in the solid spaces providing the fluid filter body and the organic material in the void spaces providing open areas. After the fluid filter is printed it is sintered at a temperature wherein the inorganic material will coalesce and the organic material will decompose.

Another of the processes for producing a fluid filter produced by additive manufacturing involves using laser sintering.

Laser Sintering

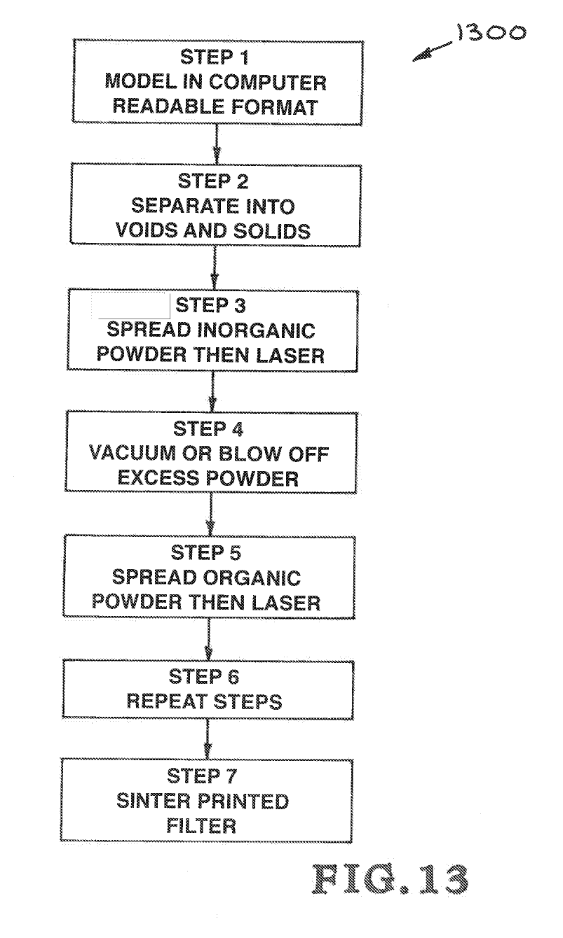

Referring now to FIG. 13, another embodiment of Applicant's fluid filter produced by additive manufacturing is illustrated by a flow chart. The flow chart illustrates a series of steps for producing Applicant's fluid filter by additive manufacturing. The steps are described below.

Step 1: Provide high resolution model of 3D filter in a computer readable format.

Step 2: Separate high resolution model of 3D filter into voids and solids.

Step 3: Using additive manufacturing system spread either organic or inorganic powder then laser bonded, light activate or otherwise caused to coalesce the voids or solid areas.

Step 4: Vacuum or blow off the excess powder.

Step 5: Using additive manufacturing system spread the other powder, and laser bonded, light activate or otherwise caused to coalesce the voids or solid areas (the alternate of step 3).

Step 6: Repeat steps 3 through 5 until the complete filter is created. Print the filter one layer at a time. Each layer will be a solid layer made up of individual ceramic or metal and organic droplets.

Step 7: Sinter the printed filter. In the sintering process the ceramic material will coalesce, and the organic material will decompose leaving the desired paths and voids in the final filter.

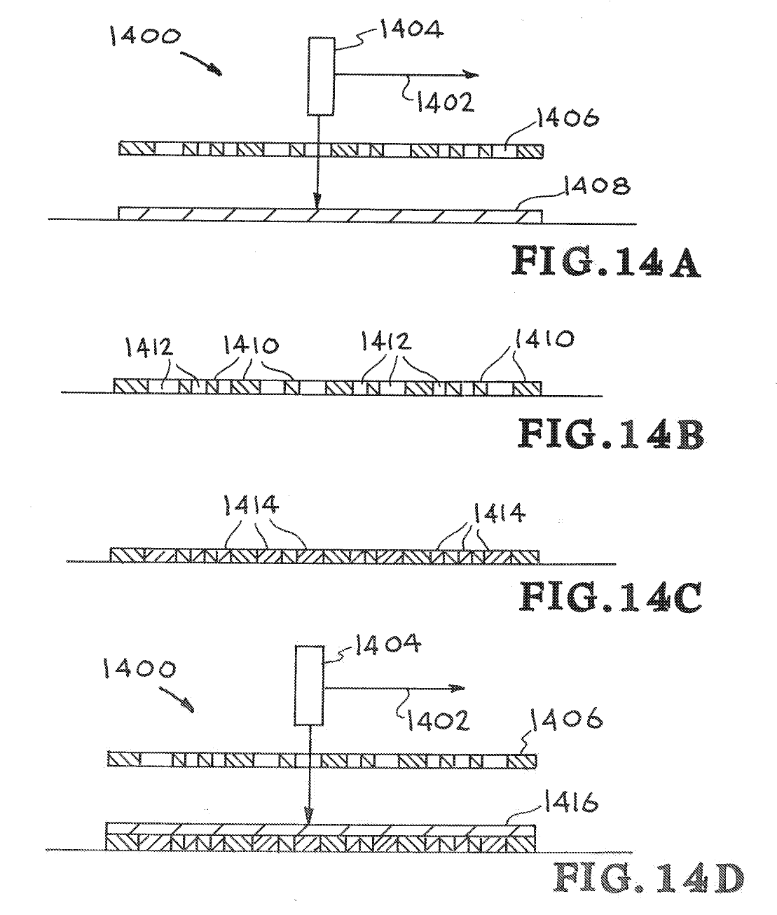

Referring now to FIGS. 14A through 14D, another embodiment of an additive manufacturing system for producing Applicant's fluid filter is illustrated. The additive manufacturing system is designated generally by the reference numeral 1400. The system 1400 produces a fluid filter using adaptive manufacturing using a laser 1404. A three dimensional model of the fluid filter in a computer readable format is produced. The three dimensional model of the fluid filter is separated into void spaces and solid spaces. The three dimensional model of the fluid filter is scanned 1402 to the laser 1404.

As illustrated in FIG. 14B, inorganic powder is spread in the solid spaces and organic material is spread in the void spaces. A powder layer 1408 is provided and a mask 1406 is positioned over the powder layer 1408. The laser 1404 is used to produce coalesced material 1410 and voids 1412.

As illustrated in FIG. 14C, the voids are filled with organic material 1414. As illustrated in FIG. 14D, the laser 1404 is used to produce the fluid filter one layer at a time wherein each layer can include said inorganic material in the solid spaces providing the fluid filter body and said organic material in the void spaces.

Once the filter is produced it is sintered. In the sintering process the in organic material will coalesce and the organic material will decompose leaving the desired structure and voids in the final filter.

Although the description above contains many details and specifics, these should not be construed as limiting the scope of the application but as merely providing illustrations of some of the presently preferred embodiments of the apparatus, systems, and methods. Other implementations, enhancements and variations can be made based on what is described and illustrated in this patent document. The features of the embodiments described herein may be combined in all possible combinations of methods, apparatus, modules, systems, and computer program products. Certain features that are described in this patent document in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination. Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described above should not be understood as requiring such separation in all embodiments.

Therefore, it will be appreciated that the scope of the present application fully encompasses other embodiments which may become obvious to those skilled in the art. In the claims, reference to an element in the singular is not intended to mean “one and only one” unless explicitly so stated, but rather “one or more.” All structural and functional equivalents to the elements of the above-described preferred embodiment that are known to those of ordinary skill in the art are expressly incorporated herein by reference and are intended to be encompassed by the present claims. Moreover, it is not necessary for a device to address each and every problem sought to be solved by the present apparatus, systems, and methods, for it to be encompassed by the present claims. Furthermore, no element or component in the present disclosure is intended to be dedicated to the public regardless of whether the element or component is explicitly recited in the claims. No claim element herein is to be construed under the provisions of 35 U.S.C. 112, sixth paragraph, unless the element is expressly recited using the phrase “means for.”

While the apparatus, systems, and methods may be susceptible to various modifications and alternative forms, specific embodiments have been shown by way of example in the drawings and have been described in detail herein. However, it should be understood that the application is not intended to be limited to the particular forms disclosed. Rather, the application is to cover all modifications, equivalents, and alternatives falling within the spirit and scope of the application as defined by the following appended claims.

The claims are:

1. A filter apparatus for providing filtration of a fluid containing particles, comprising:
a filter body having an entrance face for fluid entrance and an exit face for fluid exit,
at least one pore in said fluid filter body extending from said entrance face to said exit face wherein the fluid containing the particles flows through said at least one pore from said entrance face to said exit face, and
at least one pocket in said pore wherein the fluid containing the particles is directed into said pore and the particles become trapped in said pocket.

2. The filter apparatus for providing filtration of a fluid containing particles of claim 1 wherein said at least one pore has a section with a structural element that changes direction of the flow of fluid wherein said pocket is adjacent said section with a structural element that changes direction of the flow of fluid and the particles become trapped in said pocket.

3. The filter apparatus for providing filtration of a fluid containing particles of claim 1 wherein said at least one pore has at least one circular section that produces swirls of the fluid and wherein said pocket is adjacent said section that produces swirls and the particles become trapped in said pocket.

4. The filter apparatus for providing filtration of a fluid containing particles of claim 1 further comprising a zig zag baffle in said at least one pore wherein said pocket is in said zig zag baffle.

5. The filter apparatus for providing filtration of a fluid containing particles of claim 4 further comprising at least support baffle proximate said at least one pore and said zig zag baffle.

6. The filter apparatus for providing filtration of a fluid containing particles of claim 1 further comprising at least one circular channel in said at least one pore wherein said pocket is adjacent said at least one circular channel.

7. The filter apparatus for providing filtration of a fluid containing particles of claim 4 wherein the filter apparatus may exposed to heat and further comprising intumescent material in said at least one pore that will expand and block said at least one pore if the filter apparatus is exposed to heat.

8. The filter apparatus for providing filtration of a fluid containing particles of claim 4 wherein the fluid may contain contaminates and further comprising a reactive material in said at least one pore that will react with said contaminates if the fluid contains contaminates.

9. The filter apparatus for providing filtration of a fluid containing particles of claim 1 wherein said filter body is made of ceramic.

10. The filter apparatus for providing filtration of a fluid containing particles of claim 9 wherein said ceramic is sintered.

11. The filter apparatus for providing filtration of a fluid containing particles of claim 1 wherein said entrance face for fluid entrance is an open area for allowing the fluid being filter to enter said at least one pore.

12. The filter apparatus for providing filtration of a fluid containing particles of claim 1 wherein said entrance face for fluid entrance is an opening in said filter body for allowing the fluid being filter to enter said at least one pore.

13. A method of producing a fluid filter using adaptive manufacturing with two print heads wherein the fluid filter includes a fluid filter body having an entrance face for fluid entrance, an exit face for fluid exit, at least one pore in the fluid filter body extending from the entrance face to the exit face, and at least one pocket in the pore wherein fluid containing particles flows through the at least one pore from said entrance face to said exit face and the particles in the fluid become trapped in the pocket; comprising the steps of:
provide a three dimensional model of the fluid filter in a computer readable format,
separate said three dimensional model of the fluid filter into void spaces and solid spaces,
using one of the two print heads to print inorganic material in said solid spaces and using the other of the two print heads to print organic material in said void spaces,
print the fluid filter one layer at a time wherein each layer can include said inorganic material in said solid spaces providing the fluid filter body and said organic material in said void spaces providing the at least one pore and the pocket, and
sinter the fluid filter at a temperature wherein said inorganic material will coalesce and said organic material will decompose providing the at least one pore and the pocket in the fluid filter.

14. The method of producing a fluid filter using adaptive manufacturing with two print heads of claim 13 wherein said inorganic material is ceramic material.

15. The method of producing a fluid filter using adaptive manufacturing with two print heads of claim 13 wherein said inorganic material is metal.

16. The method of producing a fluid filter using adaptive manufacturing with two print heads of claim 13 wherein the fluid filter includes intumescent material in said at least one pore that will expand and block said at least one pore if the filter apparatus is exposed to heat and wherein said step of using one of the two print heads to print inorganic material in said solid spaces includes printing inorganic intumescent material in said solid spaces.

17. The method of producing a fluid filter using adaptive manufacturing with two print heads of claim 13 wherein the fluid may contain contaminates and wherein said step of using one of the two print heads to print inorganic material in said solid spaces includes printing inorganic reactive material in said solid spaces wherein said reactive material will react with said contaminates if the fluid contains said contaminates.

18. A method of producing a fluid filter using adaptive manufacturing wherein the fluid filter includes a fluid filter body having an entrance face for fluid entrance, an exit face for fluid exit, at least one pore in the fluid filter body extending from the entrance face to the exit face, and at least one pocket in the pore wherein fluid containing particles flows through the at least one pore from said entrance face to said exit face and the particles in the fluid become trapped in the pocket; comprising the steps of:
provide a three dimensional model of the fluid filter in a computer readable format,
separate said three dimensional model of the fluid filter into void spaces and solid spaces,
using additive manufacturing to spread inorganic powder in said solid spaces and organic material is said void spaces,
using a laser to produce the fluid filter one layer at a time wherein each layer can include said inorganic material in said solid spaces providing the fluid filter body and said organic material in said void spaces providing the at least one pore and the pocket, and
sinter the fluid filter at a temperature wherein said inorganic material will coalesce and said organic material will decompose providing the at least one pore and the pocket in the fluid filter.

19. The method of producing a fluid filter using adaptive manufacturing of claim 18 wherein said inorganic material is ceramic material.

20. The method of producing a fluid filter using adaptive manufacturing of claim 18 wherein said inorganic material is metal.

21. The method of producing a fluid filter using adaptive manufacturing of claim 18 wherein the fluid filter includes intumescent material in said at least one pore that will expand and block said at least one pore if the filter apparatus is exposed to heat and wherein said step of using a laser to produce the fluid filter one layer at a time includes using a laser to produce said inorganic intumescent material in said solid spaces.

22. The method of producing a fluid filter using adaptive manufacturing of claim 18 wherein the fluid may contain contaminates and wherein said step of using a laser to produce the fluid filter one layer at a time includes using a laser to produce said reactive material.
